(19) United States
(12) Patent Application Publication
(10) Pub. No.: US 2010/0302923 A1
(43) Pub. Date: Dec. 2, 2010

(54) DISC STARTUP TIME OF AN OPTICAL DRIVE

(75) Inventors: Tek Seow Loi, Singapore (SG); Yu Zhou, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/599,357

(22) PCT Filed: May 9, 2008
(86) PCT No.: PCT/IB2008/051857

§ 371 Date: Nov. 9, 2009

(30) Foreign Application Priority Data
May 10, 2007 (EP) 07107894.3

(51) Int. Cl. G11B 19/00

(52) U.S. Cl. 369/47.55; G9B/19.001

(57) ABSTRACT

A method of loading an optical record carrier into an optical drive is disclosed. The method comprises using a subset of a set of initial startup procedures for subsequent startups, the set of initial startup procedures comprising procedures that the optical drive requires to start recording or reading the optical record carrier. The method is useful for CD, DVD, HD-DVD and BD recorder and/or players. The method reduces the disc startup time and enhances the user satisfaction index.

### FIELD OF THE INVENTION

The subject matter relates to optical drives, and more specifically, to method for reducing the time taken by the optical drive to load an optical disc into the optical drive.

### BACKGROUND OF THE INVENTION

US patent 2005/0002308 discloses a recorder for recording data on a multi-layer optical recording medium. Loading of the multi-layer optical recording medium into the recorder (i.e. starting the optical recording medium to be ready for recording) usually can take on an average about 12 sec and can vary up to about 15 to 20 seconds. This can be quite annoying for the end user.

It would be advantageous to have a method that can reduce the time taken by a drive to load the record carrier into the drive. It would also be advantageous to have a drive that can reduce the time taken to load the record carrier into the drive.

### SUMMARY OF THE INVENTION

A method of loading an optical record carrier into an optical drive is disclosed. The method comprises using a subset of a set of initial startup procedures for subsequent startups, the set of initial startup procedures comprising procedures that the optical drive requires to start recording or reading the optical record carrier.

An optical drive comprising a control unit arranged to use a subset of a set of initial startup procedures for subsequent startups, the set of initial startup procedures comprising procedures that the optical drive requires to start recording or reading the optical record carrier is disclosed.

Furthermore, the method of loading an optical record carrier into an optical drive could be implemented with a computer program.

### BRIEF DESCRIPTION OF THE DRAWINGS

The above-mentioned aspects, features and advantages will be further described, by way of example only, with reference to the accompanying drawings, in which the same reference numerals indicate identical or similar parts, and in which:

FIG. 1 schematically shows an exemplary optical drive used for recording/reading data from an optical record carrier according to the present subject matter.

An optical record carrier, e.g. a DVD, comprises at least one track either in the form of a continuous spiral or in the form of multiple concentric circles, wherein information may be stored in the form of a data pattern. The optical record carrier may be of a Recordable (R) or a Rewritable (RW) type, wherein information may be stored or recorded, such as DVD+RW, DVD-RW, DVD+R, HD-DVD and BD-RE (single and multilayer). The information is generally recorded/played back by using radiation beams such as laser beams.

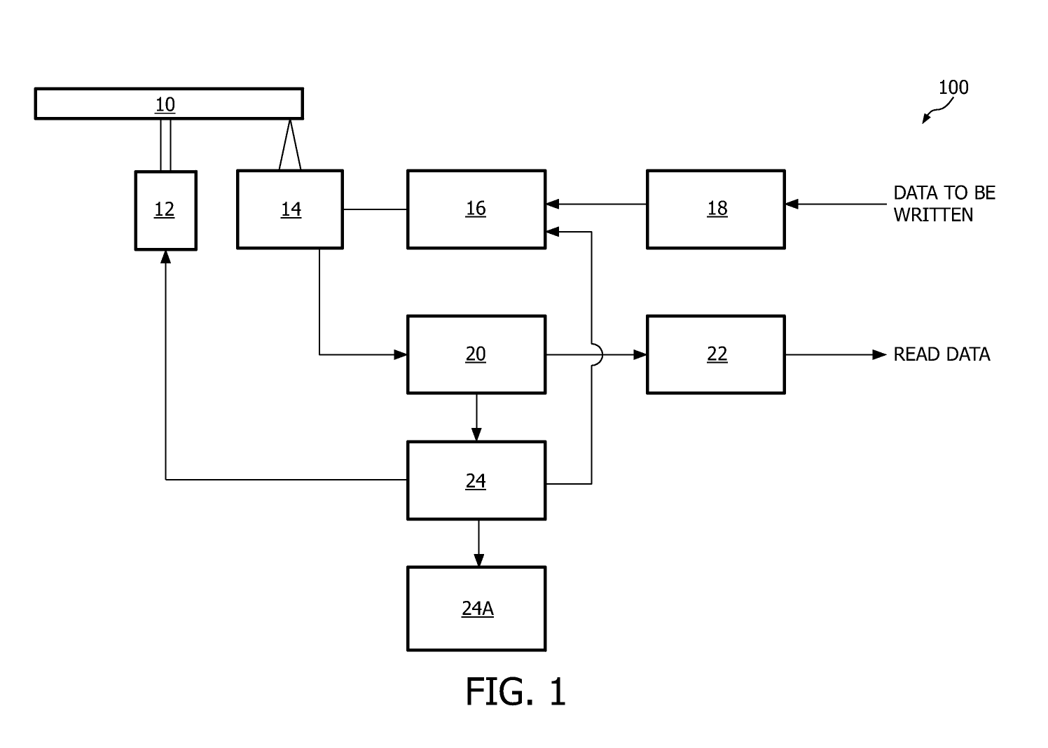

Referring now to FIG. 1, the optical record carrier 10 is constant angular velocity (CAV) controlled or constant linear velocity (CLV) controlled by a spindle motor 12.

An optical pick-up unit 14 records data on the optical record carrier 10 by using laser light (at a recording power value) emitted from a laser diode. When the data is to be recorded, it is supplied to an encoder unit 18 and the data encoded by the encoder unit 18 is supplied to a laser diode-driving unit 16. The laser diode-driving unit 16 generates a drive signal based on the encoded data and supplies the drive signal to the laser diode of the optical pick-up unit 14. In addition, a control signal from a control unit 24 is supplied to the laser diode-driving unit 16 so that the recording strategy and the recording power are determined by the control signal.

However, when data is read from the optical record carrier 10, the laser diode of the optical pick-up unit 14 emits laser light of a read power (read power<record power), and the reflected light is received. The received reflected light is converted into an electrical signal and a read RF signal is obtained. The read RF signal is supplied to an RF signal-processing unit 20.

The RF signal-processing unit 20 comprises an equalizer, a binarizing unit, a phase-locked loop (PLL) unit, and binarizes the read RF signal, generates a synchronous clock, and supplies these signals to a decoder unit 22. The decoder unit 22 decodes data based on these supplied signals and outputs the decoded data as read data.

The optical drive 100 includes a circuit (for data readout) for controlling the focus servo or tracking servo by producing a tracking error signal or a focus error signal respectively, and a wobble signal formed on the optical record carrier 10 (e.g. for use in address demodulation or for controlling the number of rotations). The servo control structures are identical to those in conventional drive systems and therefore are not described in detail.

The construction shown in FIG. 1 only illustrates portions related to the general operation of the optical drive. The description and detailed explanation of servo circuits for controlling the optical pick-up unit, the spindle motor, the slide motor, and the control circuits are omitted, because they are constructed in a similar manner as in conventional optical drives.

Loading of the optical record carrier 10 (Cf. FIG. 1) into the optical drive 100 (Cf. FIG. 1) requires the execution of the steps listed in Table 1 (before the optical drive 100 allows playback or further recording). The execution of these steps usually takes on an average of about 12 sec, and can vary up to about 15 to 20 sec (excluding the time it takes for the host to read the file system). This can be quite annoying for the end user. Efforts have been made to reduce the optical record carrier loading time, but so far, the achievement of the startup time reduction is limited (approximately to about 1 or 2 sec).

TABLE 1

| | DVD+R SL or | DVD−R SL or | | |
|---|---|---|---|---|
| Step | DVD+R DL | DVD−R DL | DVD+RW | DVD−RW |
| 1. | General optical record carrier recognition | | | |
| 2. | Tilt offset and focus offset calibration | | | |
| 3. | Read address in pre- | Read land pre-pit | Read address in pre- | Read land pre-pit |
| | groove | | groove | |

| 4. | Search for latest | Search for latest | Not applicable |
|---|---|---|---|
| | table of content | table of contents | |
| | entry | entry | |
| | (find last entry in the | (find last entry in the | |
| | Table of Contents zone | Recording Management | |
| | and/or last entry in | Area) | |
| | Session Identification | | |
| | block) | | |
| 5. | Read latest table of contents | | Read table of contents |
| 6. | | Read control data | Read control data zone |
| | | zone | |

| | | |
|---|---|---|
| 7. | Find the next writable address in data zone | Not applicable |
| | (When optical record carrier can be | |
| | appended) | |

### DETAILED DESCRIPTION OF THE EMBODIMENTS

Accordingly, a method of loading an optical record carrier into an optical drive is disclosed. The method comprises using a subset of a set of initial startup procedures for subsequent startups, the set of initial startup procedures comprising procedures that the optical drive requires to start recording or reading the optical record carrier.

The idea here is to have a procedure that learns certain optical record carrier information and forms a subset of the initial optical record carrier startup procedure. The subset of the initial optical record carrier startup procedure is used to intelligently circumvent parts of the normal optical record carrier loading steps. Hence, the time taken to subsequently load the optical record carrier into the optical drive is reduced. For example, calibration of the focus offset and the tilt offset to improve the optical record carrier readability which is carried out during the general identification of the optical record carrier can easily take about 1.8 to 2.0 seconds. The optical record carrier startup time can be reduced if this calibration step can be omitted.

In an embodiment of the method, the method includes grouping at least a portion of information related to the subset of the set of initial startup procedures and storing the grouped information in a single location on the optical record carrier for a single read access during subsequent startups. Storing the grouped information (i.e. quick load information) in a single location allows the optical drive 100 to access all the required information in a single read access and thereby perform faster loading of the optical record carrier 10. Since the required information for the optical record carrier startup is accessed and read in a single read operation, the number of access and read operations are reduced which in turn reduces the startup time. If the information related to the subset of the set of initial startup procedures is not available on the optical record carrier, that means, the optical record carrier is being loaded into the optical drive the first time. In such a case the optical drive will generate the information related to the subset of the set of initial startup procedures that can be used to reduce the time taken by the optical drive to subsequently load the optical record carrier into the optical drive.

In a still further embodiment of the method, the subset of the set of initial startup procedures comprises at least two of the initial startup procedures selected from

optical record carrier recognition;

tilt offset and focus offset calibration;

reading at least one of

an address in pre-groove and an address in land pre-pit from the optical record carrier;

reading at least one of

table of content and physical status from the optical record carrier; and

searching user data area on the optical record carrier.

Calibration of the focus offset and the tilt offset to improve the optical record carrier readability (which is carried out during general identification of the optical record carrier) usually takes about 1.8 to 2.0 seconds. The optical record carrier startup time can be reduced if this calibration step can be skipped (or omitted). Furthermore, if the optical record carrier cannot be read using the pre-calibrated focus offset and/or the pre-calibrated tilt offset value, the optical drive can revert to performing the normal calibration. This is only needed when the optical record carrier has high tilt.

Further, the last recorded table of content start address on the optical record carrier can be accessed based on the unique optical record carrier identifier without performing multiple readouts during startup. Once the subset of the set of initial startup procedures is generated, the optical drive can use the pre-calibrated focus offset and/or the pre-calibrated tilt offset value to configure the servo for optimal performance. Next, the optical drive can use the unique optical record carrier identifier to reference the last table of content address and the last user area recorded address. With this address information, the optical drive can directly read the last table of content (for the basic optical record carrier structure) thereby omitting the rest of the loading steps. This can reduce the overall optical record carrier startup time.

Furthermore, the searching of the user data area can be skipped by performing only an optical record carrier integrity check during startup. The last recorded user area address herein referred to as eeLRA kept in the non-volatile memory can be used to check the integrity of the recording. When recoding is started, the eeLRA can be cleared to zero. When recording is stopped, the eeLRA can be updated to the actual last address. In the event that the recording was interrupted due to power failure or system hang-ups, the optical drive will find that the eeLRA value is zero. This immediately flags the optical drive to perform a user area next writable address searches. With this check in place, the optical drive does not need to perform unnecessary address search which helps to reduce the optical record carrier loading time for most situations.

Furthermore, the last recorded table of content address on the optical record carrier can be updated upon completing a new recording. When there are changes to the layout structure of a recordable optical record carrier, the optical drive can update a new entry of the table of contents to the recordable optical record carrier. The location of this new table of contents entry can be kept in the optical drive's non-volatile memory. When the same optical record carrier is loaded, the optical drive can use the unique optical record carrier identifier to retrieve the location of the latest table of contents entry without the need to search the optical record carrier

Furthermore, the last table of content stop address can be stored in a memory of an optical drive associated with an optical record carrier type. The stored last table of content stop address can be used upon loading the optical record carrier type into the optical drive. Furthermore, if the subset of the set of the set of initial startup procedures (i.e. quick load information) is not found, the optical drive can read the table of contents from the beginning of the table of contents defined address. Alternatively, the optical drive can read the control data zone in the case of DVD-R disc.

As an illustrative example for a blank optical record carrier, or an optical record carrier that does not contain the “quick load information”, the difference in the loading sequence is shown in Table 2.

TABLE 2
Loading optical record carrier 10 into the optical drive 100
(Cf. FIG. 1) without “quick load information”

| | Original loading | New loading | Original loading | New loading |
|---|---|---|---|---|
| | steps for blank | step for blank | steps for blank | step for blank |
| Step | recordable disc | recordable disc | rewritable disc | rewritable disc |
| 1 | General disc recognition | | | |
| 2 | Tilt offset/focus | | Tilt offset/focus | |
| | offset calibration | | offset calibration | |
| 3 | Read address in | | Read address in | |
| | pre-groove/land | | pre-groove/land | |
| | pre-pit | | pre-pit | |
| 4 | | Read “quick load | Read table of | Read table of |
| | | information” | contents | contents and |
| | | (empty) | | “quick load |
| | | | | information” |
| | | | | empty) |
| 5 | | Tilt offset/focus | | Tilt offset/focus |
| | | offset calibration | | offset calibration |
| 6 | | Read address in | | Read address in |
| | | pre-groove/land | | pre-groove/land |
| | | pre-pit | | pre-pit |

| 7 | Find latest table of content entry |
|---|---|
| 8 | Read latest table of contents entry |
| | (non-blank disc only) |
| 9 | Read Control Data Zone |
| 10 | Search user data area |

Initially step 2 and step 3 are skipped. However, the step to read the “quick load information” from the disc can fail. This can force the optical drive to carry out step 5 and 6 (same step as 2 and 3) before following the original disc loading sequence. Once the disc is loaded and recording is initiated, the optical drive will have enough information to store the “quick load information” to the disc (in specific location in the lead-in). This can allow the optical drive to perform faster loading of the same disc in the future.

As an illustrative example, Table 3 shows loading a DVD according to an embodiment of the disclosed method (i.e. with the quick load information). When the “quick load information” is available, certain steps of the original loading steps are skipped in order to improve the DVD loading time.

TABLE 3
Loading DVD with “quick load information”

| | Basic loading steps | New loading steps | Basic loading steps | New loading steps |
|---|---|---|---|---|
| Steps | for recordable DVD | for recordable DVD | for rewritable DVD | for rewritable DVD |
| 1 | General disc recognition | | | |
| 2 | Tilt offset/Focus | | Tilt offset/Focus | |
| | offset calibration | | offset calibration | |
| 3 | Read address in | | Read address in | |
| | pre-groove/land | | pre-groove/land | |
| | pre-pit | | pre-pit | |
| 4 | Search latest table | Read “quick load | | |
| | of contents entry | information” | | |
| 5 | Read latest table of contents entry | | Read table of | Read table of |
| | | | contents entry | contents entry |
| | | | | (include “quick |
| | | | | load information”) |
| 6 | Read control data | | Read control data | |
| | zone | | zone | |
| 7 | Search user data | | | |
| | area | | | |

Referring now to Table 3, after the general disc recognition step has been completed, the optical drive can read the “quick load information”. With this information, the optical drive will be able to immediately update its servo settings for tilt offset and focus offset with the optimal values found in the “quick load information”. Steps 3 and 6 are skipped because the optical drive already has a copy of the address in pre-groove/land pre-pit information and the control data zone information from the quick load information” block.

Additionally, the “quick load information” contains the unique disc identifier. This unique disc identifier is used to skip steps 4 and 7 in the original loading sequence for recordable disc only. Steps 4 and 7 are not carried for rewritable disc, so this part of the improvement is not applicable for rewritable disc.

For recordable disc, steps 4 and 7 are skipped because the optical drive will now be able to use the non-volatile memory to store the address of the last table of contents entry as well as the last recorded address of the user data area using the unique disc identifier as the reference key. Without the unique disc identifier, values stored in the optical drive's non-volatile memory cannot be accurately applied to a specific disc.

When there are changes to the layout structure of a recordable optical record carrier, the optical drive will update a new entry of the table of contents to the recordable optical record carrier. The location of this new table of contents entry will be kept in the optical drive's non-volatile memory. When the same optical record carrier is loaded, the optical drive will use the unique disc identifier (read from the “quick load information”) to retrieve the location of the latest table of contents entry without the need to search the optical record carrier.

In addition to storing the location of the latest table of contents entry, the optical drive will also store the last recorded address of the user data area in its non-volatile memory. When the same optical record carrier is loaded, the optical drive will use the unique disc identifier to retrieve the last recorded address from its non-volatile memory. This will allow the optical drive to skip step 7. Furthermore, in order to provide a quick check on data integrity on the disc, the following method can be used. When recording is started, the last recorded address in the non-volatile memory will be cleared to zero to denote that recording has started. When recording is stopped, the actual last recorded address is stored into the optical drive's non-volatile memory. In the event that a recording was started but was not completed (i.e. recording was interrupted due to power failure or system hang-ups), the optical drive will find that the last recorded address value in the non-volatile memory is zero. By seeing a value of zero, the optical drive will know that the recording on this did not complete successfully and that the information contained in the table of content is not up-to-date. In order to reflect the latest disc layout structure, the optical drive will need to perform a next writable address search in the user data area. With this data area integrity check in place, the optical drive will be able to skip the data area search step for most situations when recordings have completed successfully.

Referring now to FIG. 1, the optical drive 100 can be adapted to reduce the optical record carrier startup time as disclosed in the embodiments. To this end, the optical drive 100 includes a control unit 24A arranged to use a subset of the set of initial startup procedures (i.e. quick load information) for subsequent startups, the set of initial startup procedures comprising procedures that the optical drive requires to start recording or reading the optical record carrier. In operation, the optical drive reduces the time taken to load the optical record carrier into the optical drive.

A recorder or player (e.g. DVD recorder and/or player, CD recorder and/or player, BD recorder and/or player, or HD-DVD recorder and/or player) having the optical drive can reduce the time taken by the optical drive to load the optical record carrier into the optical drive (i.e. to be ready for recording/reading). A successful startup is a critical performance indicator of a disc layer/recorder from the user's perspective. Therefore, when the optical record carrier loading is fast, the user will have a higher satisfaction index of the recorder or player (as compared to slower optical record carrier loading time).

Although the present subject matter has been explained by embodiments using example discs and example drives such as DVD discs and DVD drives, the subject matter is applicable to all types of record carriers and drives. A person skilled in the art can implement the described embodiments of the method in software or in both hardware and software. Other variations to the disclosed embodiments can be understood and effected by those skilled in the art of practicing the claimed subject matter, from a study of the drawings, the disclosure and the appended claims. Use of the verb “comprise” and its conjugates does not exclude the presence of elements other than those stated in a claim or in the description. Use of the indefinite article “a” or “an” preceding an element or step does not exclude the presence of a plurality of such elements or steps. The Figures and description are to be regarded as illustrative only and do not limit the subject matter.

1. A method of loading an optical record carrier into an optical drive comprising:
using a subset of a set of initial startup procedures for subsequent startups, the set of initial startup procedures comprising procedures that the optical drive requires to start recording or reading the optical record carrier.

2. The method as claimed in claim 1, further comprising:
grouping at least a portion of information related to the subset of the set of initial startup procedures and storing the grouped information in a single location on the optical record carrier for a single read access during subsequent startups.

3. The method as claimed in claim 2, wherein the subset of the set of initial startup procedures comprises at least two of the initial startup procedures selected from the following:
optical record carrier recognition;
tilt offset and focus offset calibration;
reading at least one of
an address in pre-groove and an address in land pre-pit from the optical record carrier;
reading at least one of
table of content and physical status from the optical record carrier; and
searching user data area on the optical record carrier.

4. An optical drive (100) comprising:
a control unit (24A) arranged to use a subset of a set of initial startup procedures for subsequent startups, the set of initial startup procedures comprising procedures that the optical drive requires to start recording or reading the optical record carrier.

5. The optical drive as claimed in claim 4, wherein the control unit is further arranged to:
group at least a portion of information related to the subset of the set of initial startup procedures and store the grouped information in a single location on the optical record carrier for a single read access during subsequent startups.

6. The optical drive as claimed in claim 5, wherein the control unit is further arranged to:
use the subset of the set of initial startup procedures comprising at least two of the initial startup procedures selected from the following:
optical record carrier recognition;
tilt offset and focus offset calibration;
reading at least one of
an address in pre-groove and an address in land pre-pit from the optical record carrier;
reading at least one of
table of content and physical status from the optical record carrier; and
searching user data area on the optical record carrier.

7. An optical disc recorder or player comprising the optical drive as claimed in claim 4.

8. A computer program comprising program code means to perform a method, the method comprising:
using a subset of a set of initial startup procedures for subsequent startups, the set of initial startup procedures comprising procedures that the optical drive requires to start recording or reading the optical record carrier.
